(19) United States
(12) Patent Application Publication
(10) Pub. No.: US 2023/0354077 A1
(43) Pub. Date: Nov. 2, 2023

(54) EVENT-BASED REPORTING OF BEAM-RELATED PREDICTION

(71) Applicant: QUALCOMM Incorporated, San Diego, CA (US)

(72) Inventors: Tianyang Bai, Somerville, NJ (US); Hua Wang, Basking Ridge, NJ (US); Taesang Yoo, San Diego, CA (US); Junyi Li, Fairless Hills, PA (US); Tao Luo, San Diego, CA (US)

(21) Appl. No.: 18/308,574

(22) Filed: Apr. 27, 2023

Related U.S. Application Data
(60) Provisional application No. 63/363,940, filed on Apr. 29, 2022.

(51) Int. Cl. H04W 24/10; H04W 72/21; H04W 72/04; H04W 72/56

(52) U.S. Cl. CPC H04W 24/10; H04W 72/21; H04W 72/04; H04W 72/56

(57) ABSTRACT

An apparatus may be a user equipment (UE) or a component thereof. The apparatus may be configured to generate measurement information corresponding to a set of signals received from a base station, wherein the set of signals corresponds to a set of beams. The apparatus may be further configured to generate, based on the measurement information, first predicted information, wherein the first predicted information corresponds to at least one beam with which to communicate with the base station. The apparatus may be further configured to determine, based on the first predicted information, that one or more conditions are satisfied. The apparatus may be further configured to transmit, to the base station based on the determination, a first report including second predicted information, wherein the second predicted information includes the first predicted information or the second predicted information is a subset of the first predicted information.

This application claims the benefit of U.S. Provisional Application No. 63/363,940, filed Apr. 29, 2022, the entire contents of which are hereby incorporated by reference.

### INTRODUCTION

The present disclosure generally relates to communication systems, and more particularly, to reporting a prediction associated with at least one beam of a set of beam based on detection of an event.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE) or a component thereof. The apparatus may be configured to generate measurement information corresponding to a set of signals received from a base station, wherein the set of signals corresponds to a set of beams. The apparatus may be further configured to generate, based on the measurement information, first predicted information, wherein the first predicted information corresponds to at least one beam with which to communicate with the base station. The apparatus may be further configured to determine, based on the first predicted information, that one or more conditions are satisfied. The apparatus may be further configured to transmit, to the base station based on the determination, a first report including second predicted information, wherein the second predicted information includes the first predicted information or the second predicted information is a subset of the first predicted information.

In another aspect of the disclosure, another method, another computer-readable medium, and another apparatus are provided. The other apparatus may be a base station or a component thereof. The other apparatus may be configured to receive, from a UE, a first report including first predicted information corresponding to at least one first beam of a set of beams with which to communicate with the UE, the first predicted information being based on a set of signals respectively corresponding to a subset of the set beams. The other apparatus may be further configured to select at least one second beam of the set of beams based on the first predicted information. The other apparatus may be further configured to transmit, to the UE, information identifying the at least one second beam of the set of beams. The other apparatus may be further configured to communicate with the UE via the at least one second beam of the set of beams.

In another aspect of the disclosure, a first network node for wireless communication includes a memory; and at least one processor coupled to the memory. The at least one processor is configured to generate measurement information corresponding to a set of signals received from a second network node, wherein the set of signals corresponds to a set of beams; generate, based on the measurement information, first predicted information, wherein the first predicted information corresponds to at least one beam with which to communicate with the second network node; determine, based on the first predicted information, that one or more conditions are satisfied; and transmit, to the second network node based on the determination, a first report including second predicted information, wherein the second predicted information includes the first predicted information or the second predicted information is a subset of the first predicted information.

In another aspect of the disclosure, a first network node for wireless communication includes a memory; and at least one processor coupled to the memory. The at least one processor is configured to receive, from a second network node, a first report including first predicted information corresponding to at least one first beam of a set of beams with which to communicate with the second network node, the first predicted information being based on a set of signals respectively corresponding to a subset of the set beams; select at least one second beam of the set of beams based on the first predicted information; transmit, to the second network node, information identifying the at least one second beam of the set of beams; and communicate with the second network node via the at least one second beam of the set of beams.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a diagram illustrating an example of a prediction function.

FIG. 5 is a diagram illustrating an example of a prediction function configured to predict measurements for beams.

FIG. 6A is diagram illustrating an example of a UE in communication with a base station having a prediction function.

FIG. 6B is diagram illustrating an example of a base station having a prediction function in communication with a UE.

FIG. 6C is diagram illustrating an example of a base station having a prediction function in communication with a UE having a prediction function.

FIG. 7 is a diagram illustrating an example of a prediction function that is configured to receive at least one measurement as an input and to provide a predicted measurement and a confidence score for the predicted measurement as outputs.

FIG. 8 is a call flow diagram illustrating an example of a UE that is configured to report a confidence score associated with a predicted measurement to a base station based on a configuration provided by the base station.

FIG. 9 is a flowchart illustrating an example of a method of wireless communication at a UE.

FIG. 10 is a flowchart illustrating an example of a method of wireless communication at a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

As described herein, a node (which may be referred to as a node, a network node, a network entity, or a wireless node) may include, be, or be included in (e.g., be a component of) a base station (e.g., any base station described herein), a user equipment (UE) (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more components, a first processing entity, or the like configured to receive the information; and the second network node may refer to a second UE, a second base station, a second apparatus, a second device, a second computing system, a second set of one or more components, a second processing entity, or the like.

In some radio access networks (RANs), a base station may configure at least one beam of a set of beams for communication with a UE. As part of such configuration, the UE may obtain a set of measurements associated with the set of beams, e.g., based on reference or pilot signals transmitted by the base station via each of the set of beams. For example, the UE may measure a reference signal receive power (RSRP), a reference signal receive quality (RSRQ), signal-to-noise ratio (SNR), signal-to-interference-plus-noise ratio (SINR), and/or other similar metric. The UE may report a subset of the set of measurements to the base station, and the base station may configure the beam with which to communicate with the UE based on the reported measurements.

In some instances, the UE will obtain appreciably more measurements than the UE should report to the base station. For example, the UE may be configured to report the highest or “best” K (e.g., K may be equal to two (2), four (4), eight (8), or another value) measurements to base station in a beam report, such as a Layer 1 (L1) beam report. In some aspects, the UE may quantize the reported measurement(s).

As the capabilities of UEs have expanded, such as through increased computational power (e.g., graphics processing units (GPUs), advances in the machine learning domain, etc.), the information provided by a UE in a beam report may be more robust and some processing overhead associated with beam selection can be offloaded from the base station to the UE. In particular, a UE may be configured to predict measurements associated with one or more beams based on historical measurements obtained through receiving the one or more beams.

A UE may be configured with a beam prediction function, such as a neural network function (NNF) (e.g., a machine learning function, an artificial intelligence (AI) function, and/or a deep learning function), a minimum mean square error (MMSE) function, or the like. A beam prediction function may map a set of inputs to a set of outputs, for example, based on a set of algorithms or activation functions that may be weighted, based on minimization of the mean square error (MSE) of fitted values of a dependent variable, based on estimation with a quadratic loss function, etc. Some parameters (e.g., weights) may be adjustable so that the beam prediction function can be tuned or refined as new datasets are provided thereto. Some other examples of the beam prediction function include machine learning algorithms, convolutional neural networks (CNNs), recurrent neural networks (RNNs), deep learning algorithms, long short-term memory (LSTM), and the like.

In some examples, historical measurements (e.g., “actual” measurements or “physical” measurements) may be provided as inputs to a beam prediction function, and a set of predicted measurements may be provided in response as outputs. The UE may be configured to report a subset of the set of predicted measurements to the base station, which may improve link quality and/or reduce instances of link failure relative to historical measurements. The predicted measurements may offer some improvements over the historical measurements because the predicted measurements may be relevant to the time at which a base station configures a beam for communication with the UE, whereas the latency inherent in using historical measurements may render those historical measurements obsolete.

Not all predicted measurements will justify beam reporting, however, as excessive reporting may introduce overhead in terms of network resources, processor consumption, power consumption, and so forth. Thus, there exists a need to balance the instrumentality of timely reporting for configuring over-the-air communication with the overhead commensurate with such reporting.

The present disclosure describes various techniques and approaches to beam reporting that may reduce or mitigate some or all of the aforementioned overhead. In particular, a UE may be configured to report predictions that are likely to be useful to the base station when configuring communication with the UE based on at least one condition (e.g., an event or a trigger), such as when a radio link failure is expected or when another beam is predicted to offer better channel quality than a current serving beam. To do so, the UE may be configured to transmit a beam report having predicted information based on the event being satisfied. In other words, a UE may be configured, by a base station, for event-based reporting of the predicted information, and when the UE detects a certain event, the UE may report predicted information that may be used by the base station to configure communication with the UE.

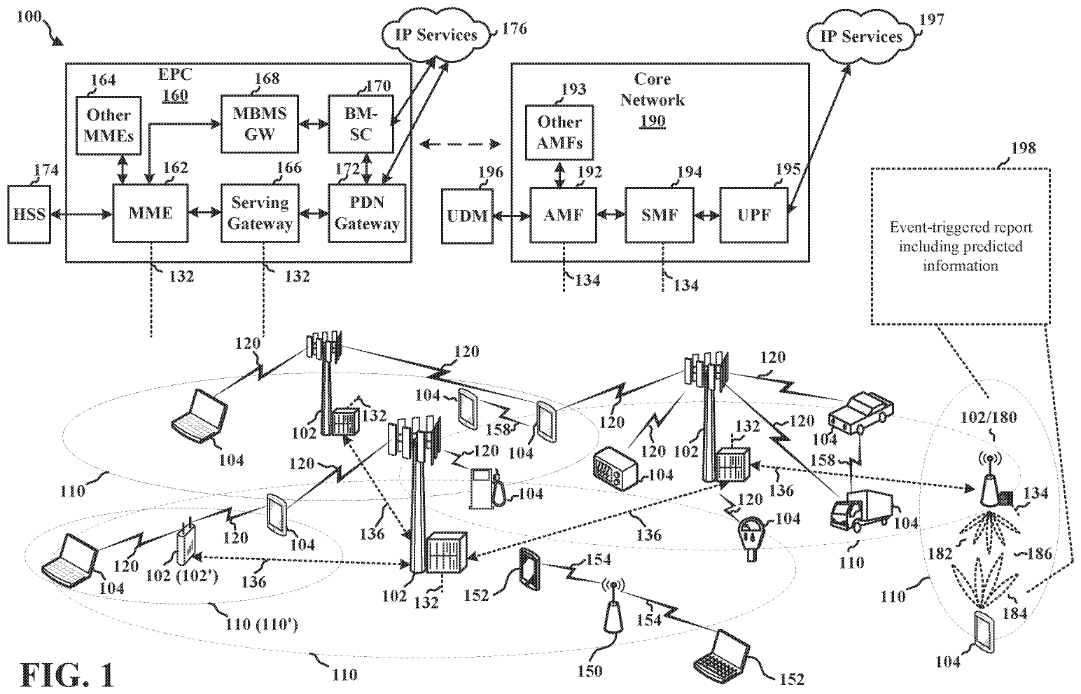

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as Next Generation RAN (NG-RAN), may interface with core network 190 through second backhaul links 134. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for IAB. Accordingly, such base stations may wirelessly communicate with other base stations, which also may be configured for IAB.

At least some of the base stations 102 configured for IAB may have a split architecture that includes at least one of a CU, a DU, an RU, a radio unit, and/or a remote radio head (RRH), some or all of which may be collocated or distributed and/or may communicate with one another. In some configurations of such a split architecture, a CU may implement some or all functionality of a radio resource control (RRC) layer, whereas a DU may implement some or all of the functionality of a radio link control (RLC) layer.

Illustratively, some of the base stations 102 configured for IAB may communicate through a respective CU with a DU of an IAB donor node or other parent IAB node (e.g., a base station), and further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190. With such a connection to the EPC 160 and/or core network 190, a base station 102 operating as an IAB donor may provide a link to the EPC 160 and/or core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102, whether a small cell 102′ or a large cell (e.g., macro base station), may include and/or be referred to as an eNB, gNodeB (gNB), or another type of base station. Some base stations 180, such as gNBs, may operate in a traditional sub 6 GHz spectrum, in mmW frequencies, and/or near-mmW frequencies in communication with the UE 104. When such a base station 180 (e.g., gNB) operates in mmW or near-mmW frequencies, the base station 180 may be referred to as a mmW base station. The (mmW) base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects, the UE 104 may be configured to generate measurement information corresponding to a set of signals received from the base station 102/180. The set of signals may correspond to a set of beams of the base station 102/180. The UE 104 may be further configured to generate, based on the measurement information, first predicted information, which may correspond to at least one beam with which to communicate with the base station 102/180. The UE 104 may be further configured to determine, based on the first predicted information, that one or more conditions are satisfied. The UE 104 may be further configured to transmit, to the base station 102/180 based on the determination, a first report 198 including second predicted information, and the second predicted information may include at least a subset of the first predicted information.

Correspondingly, the base station 102/180 may be configured to receive, from the UE 104, the first report 198 including the second predicted information corresponding to at least one first beam of a set of beams with which to communicate with the UE 104. The base station 102/180 may be further configured to select at least one second beam of the set of beams based on the second predicted information included in the first report 198. The base station 102/180 may be further configured to transmit, to the UE 104, information identifying the at least one second beam of the set of beams. The base station 102/180 may be further configured to communicate with the UE 104 via the at least one second beam of the set of beams.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

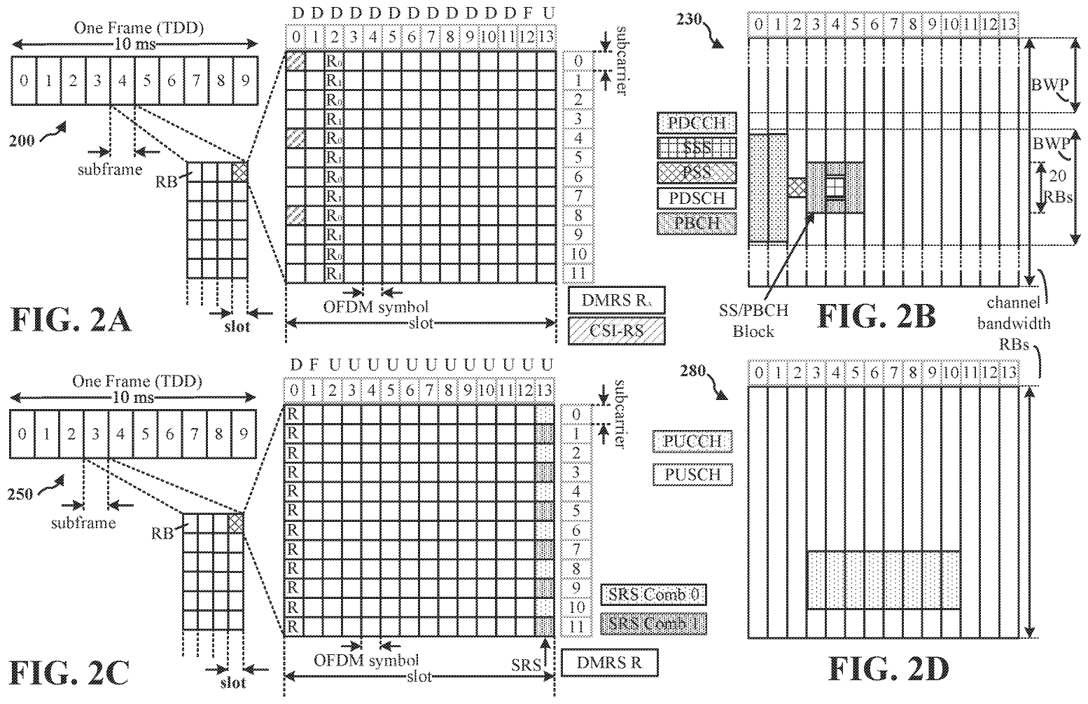

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology there are 14 symbols/slot and 211 slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rₓ for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

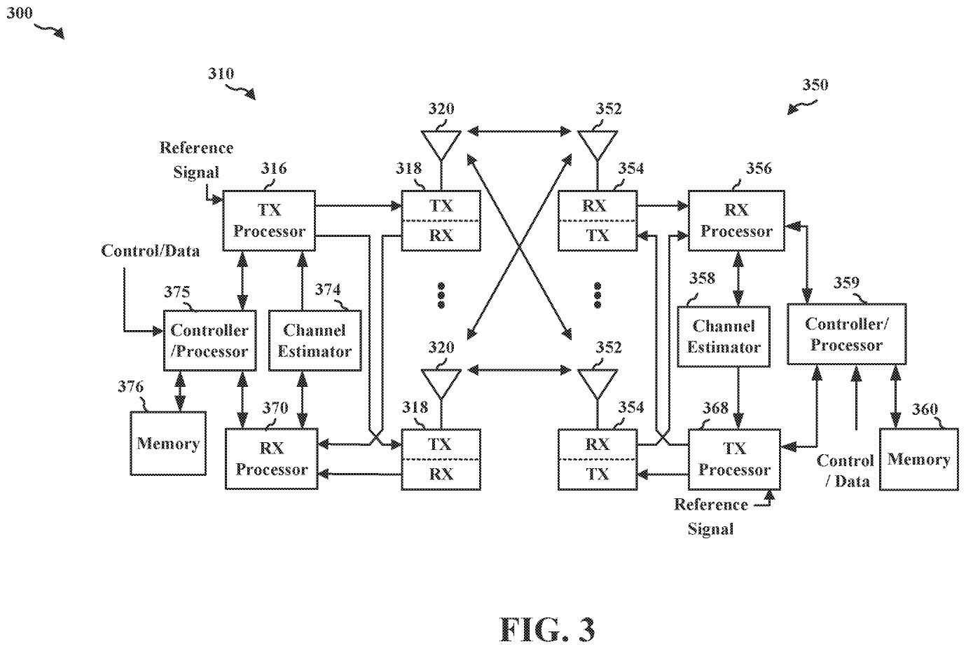

FIG. 3 is a block diagram of a base station 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 368, the RX processor 356, and the controller/processor 359 may be configured to perform aspects in connection with event-triggered first report 198 including the predicted information of FIG. 1.

In some other aspects, at least one of the TX processor 316, the RX processor 370, and the controller/processor 375 may be configured to perform aspects in connection with the event-triggered first report 198 including the predicted information of FIG. 1.

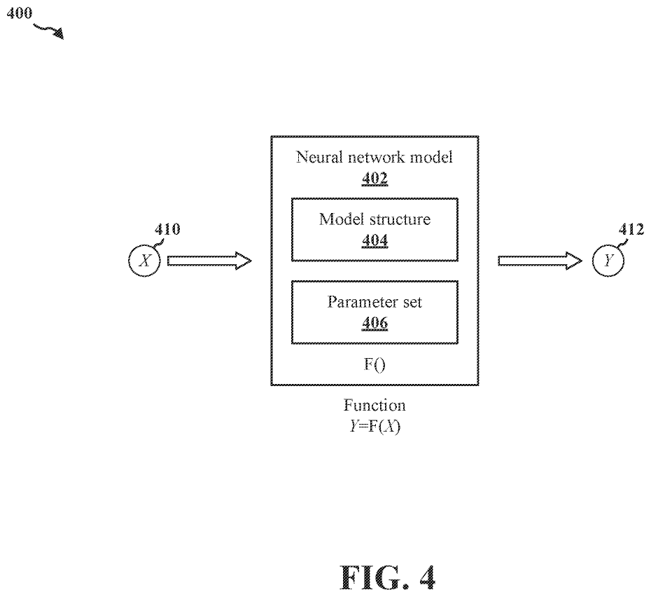

FIG. 4 is a diagram illustrating an example of a prediction function 400. The prediction function 400 may be a function, e.g., represented as Y=F(X), and may be identifiable via an identifier (ID), such as a neural network function (NNF) ID, which may be standardized or non-standardized (e.g., non-standardized for private extensions). The prediction function 400 may be configured to accept an input X 410 and return an output Y 412 and, in some aspects, the input X 410 and the output Y 412 may be standardized.

In some aspects, the prediction function 400 may be implemented at a UE, and in some further aspects, a prediction function implemented at a UE may be configurable by a base station. For example, a base station may transmit one or more RRC signaling messages to the UE to configure the prediction function of the UE. Such RRC signaling messages may include some information elements (IEs) that may be compulsory, e.g., to obtain accurate outputs of the prediction function 400, and/or some IEs that may be optional, e.g., to facilitate flexibility across implementations of prediction functions.

The prediction function 400 may be supported by a model, such as a neural network model 402. Examples of the neural network model 402 may include, inter alia, long short-term memory (LSTM), a convolutional neural network (CNN), a recurrent neural network (RNN), an attention model, a deep-learning model, and so forth. However, other models may be used without departing from the scope of the present disclosure. For example, the neural network model 402 may be replaced by or supplemented with a filter-based model, such as an MMSE filtering model, an optimization model, such as a Bayesian optimization model, or other such statistical model.

The neural network model 402 may include a model structure 404 and a parameter set 406. The neural network model 402 may be implementation-specific, and may be defined by a mobile network operator (MNO), a vendor (e.g., a UE vendor or a base station vendor), and/or another entity. In some aspects, one prediction function can be supported by multiple models (e.g., vendor-specific implementation).

In the neural network model 402, the model structure 404 may be identifiable via a model ID, which may include a default parameter set. Such a model ID may be unique in the network, and each model ID may be associated with a prediction function. The parameter set 406 may include weights of the neural network model 402, as well as other configuration parameters. The parameter set 406 may be specific to a location and/or configuration.

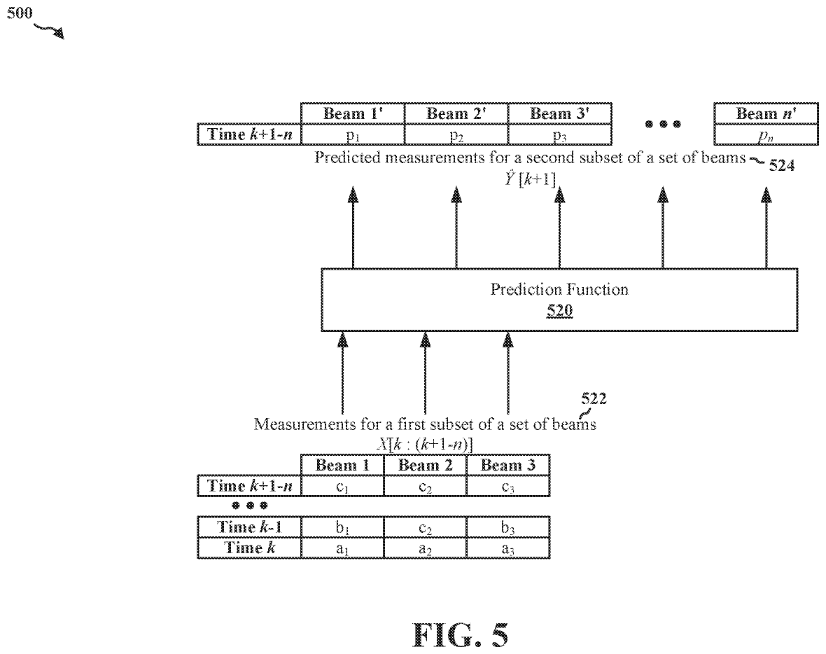

FIG. 5 is a diagram illustrating an example of a prediction function 520 configured to predict measurements 524 for beams. The prediction function 520 may include a set of algorithms that may be designed to predict measurements at a future time, such as a future RSRP or future SNR, based on historical measurements obtained based on receiving signals from the base station 502.

In some aspects, the set of algorithms may include at least one of a neural network, such as a RNN or other neural network composed of a set of interconnected activation functions, a set of algorithms for filtering and/or optimization, and/or another set of algorithms. In some aspects, the set of algorithms may be trained and maintained by a base station. In some other aspects, the set of algorithms can be executed by the base station and/or the UE. When executed at the UE, the set of algorithms may be configured by the base station.

A UE may be configured to obtain actual measurements 522 for a first subset of a set of beams (e.g., beams having IDs 1, 2, and 3) at a plurality of time steps k, k−1, k+1−n. These actual measurements 522 may be represented in a vector having a number of elements equal to the number of beams being tracked by the UE (e.g., three (3) beams, eight (8) beams, twenty-four (24) beams, etc.), with each time step k, k−1, k+1−n being represented in a respective vector. Such vectors may be provided to the prediction function 520 as inputs. The prediction function 520 may return a set of outputs that may include predicted measurements 524 for a second subset of the set of beams.

For example, the UE may measure a subset of a set of signals (e.g., SSBs, CSI-RSs, etc.) transmitted by the base station in order to predict measurements for one, some, or all signals (e.g., SSBs, CSI-RSs, etc.) at a future time step. For example, the UE may measure SSBs to predict measurements for refining CSI-RS beams for unicast PDSCH/PDCCH. In some other example, the prediction function 520 may be configured to provide an ID of a beam predicted to be the “best” at a future time step (e.g., a beam predicted to have a highest RSRP, highest SNR, other similar metric).

Thus, the prediction function 520 may serve to reduce the overhead commensurate with reference signal transmission. As some measurements may be predicted rather than actual, the frequency with which reference signals are transmitted to track beam or channel qualities may be reduced. Further, a UE may refrain from feeding back channel estimations to the base station so frequently. Further, a UE may conserve more power by refraining from measuring and feeding back measurements to a base station so frequently.

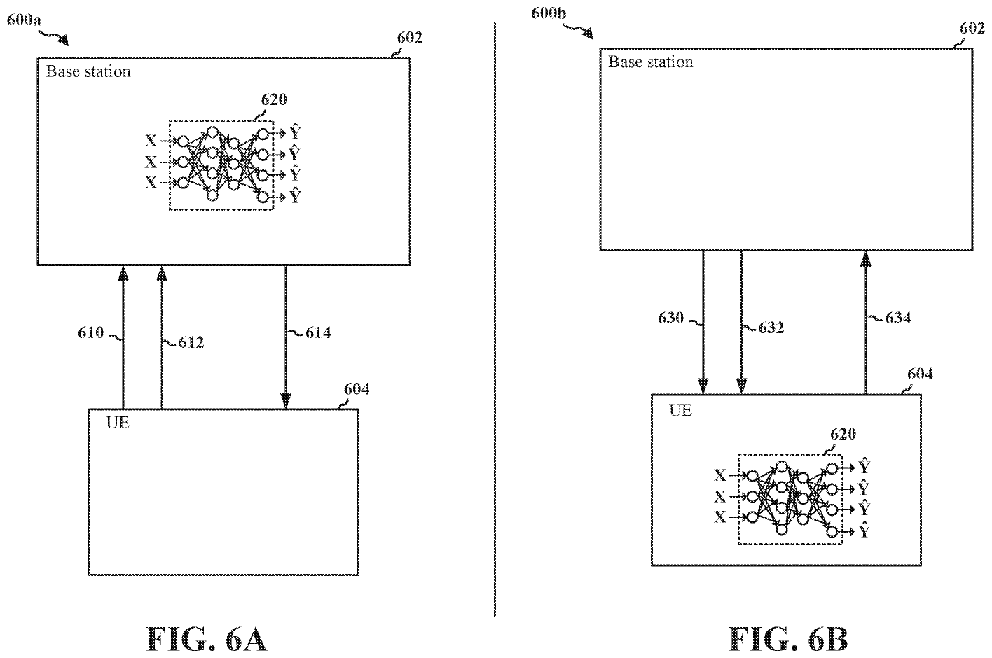

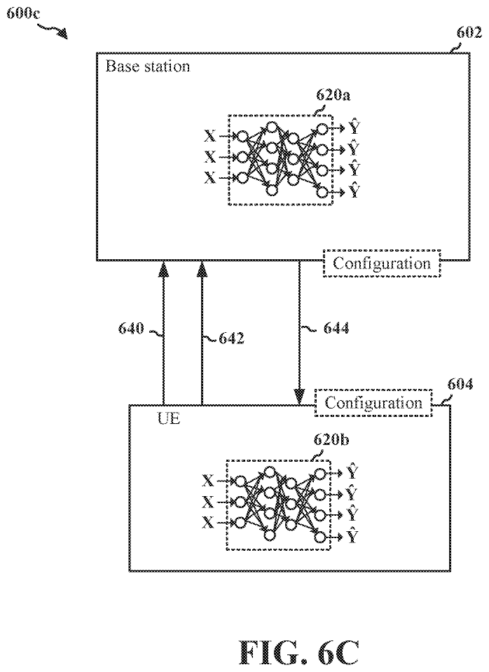

FIG. 6A is diagram illustrating an example configuration 600a of a UE 604 in communication with a base station 602 having a prediction function 620. In the illustrated configuration 600a, the prediction function 620 may be executed at the base station 602. In such an aspect, the UE 604 may transmit, to the base station 602, a CSI or beam report 610. In some other aspects, the UE may additionally or alternatively transmit a set of SRSs 612 that the base station 602 may be configured to detect and measure.

The base station 602 may execute the prediction function 620 based on at least one of UE feedback (e.g., CSI or beam report 610) and/or SRSs 620 transmitted by the UE 604. Based on an output(s) of the prediction function, base station 602 may be configured to transmit, to the UE 604, information 614 indicating at least one of a predicted measurement(s) and/or a schedule or resource allocation for the UE 604 on a beam that is predicted to have an acceptable and reliable measurement at a future time step. Such a configuration 600a may be particularly useful when power and/or processing capacity are limited at the UE 604.

FIG. 6B is diagram illustrating an example configuration 600b of a base station 602 having a prediction function 620 in communication with a UE 604. In the illustrated configuration, the prediction function 620 may be executed at the UE 604. However, the prediction function 620 may be configured by the base station 602 for the UE 604. To that end, the base station 602 may transmit a prediction function configuration 630 to the UE 604 that may include a set of weights and/or parameters with which to configure the prediction function 620.

Further, the base station 602 may transmit a set of reference signals 632 to the UE 604. The UE 604 may determine measurement information based on receiving the set of reference signals 632. For example, the UE 604 may measure an RSRP or an SNR based on receiving at least one of the reference signals 632. The UE 604 may execute the prediction function 620, configured with the prediction function configuration 630, using the determined measurement information (e.g., actual measurements based on the reference signals 632). The UE 604 may obtain one or more outputs of the prediction function 620, which may include predicted measurements based on the input measurement information. The UE 604 may transmit, to the base station 602, a report 634 that indicates the predicted measurements obtained based on output(s) of the prediction function 620.

The configuration 600b in which the prediction function 620 is implemented at the UE 604 may be advantageous in terms of accuracy, as the UE 604 may have more actual measurements than those reported to the base station 602, and further, the signaling overhead commensurate with transmitting or receiving predicted measurements may be reduced relative to the first configuration 600a.

FIG. 6C is diagram illustrating an example configuration 600c of a base station 602 having a prediction function 640 in communication with a UE 604 having a prediction function 640. In the illustrated configuration 600c, one prediction function 620a may be executed at the base station 602, and another prediction function 620b may be executed at the UE 604.

The prediction function 620b at the UE 604 may be configured by the base station 602. In such an aspect, the base station 602 may transmit a prediction function configuration 640 to the UE 604, and the prediction function configuration 640 may configure the UE-side prediction function 620b to be consistent with the base station-side prediction function 620a.

For example, the prediction function configuration 640 may include a set of weights or parameters that is based on a corresponding set of weights or parameters with which the base station-side prediction function 620a is configured. In some aspects, the prediction function configuration 640 may configure the UE-side prediction function 620b to generate one or more output(s) that are the same or substantially similar to one or more corresponding output(s) of the base station-side prediction function 620a, e.g., when the prediction functions 620a, 620b are provided the same set of inputs.

In some aspects, the outputs of the prediction functions 620a, 620b may be based on actual measurements taken from reference signals 642 transmitted by the base station 602. The UE 604 may determine measurement information based on receiving the set of reference signals 642. For example, the UE 604 may measure an RSRP or an SNR based on receiving at least one of the reference signals 642. The UE 604 may report at least a portion of the measurement information (e.g., including at least a portion of the actual measurements that are based on the reference signals 642) to the base station 602 in a CSI or beam report 610.

With inputs based on the measurement information, each of the base station 602 and the UE 604 may independently execute a respective prediction function 620a, 620b. As the prediction function configuration 630 configures the UE-side prediction function 620b to be consistent with the base station-side prediction function 620a, each of the prediction functions 620a, 620b may independently generate a respective set of outputs (e.g., set of predicted measurements) that is the same or substantially similar given the same set of inputs that is based on the measurement information.

When the base station 602 and the UE 604 are provided the same set out outputs from the respective prediction functions 620a, 620b, the base station 602 and the UE 604 may autonomously configure communication with one another without any signaling overhead (or with appreciably reduced signaling overhead). The base station 602 and the UE 604 may be synchronized for the autonomous configuration 646a, 646b, and because the respective sets of outputs may indicate the same predicted measurements, the autonomous configuration 646b by the UE 604 may result in identification of a beam that the base station 602 will select to communicate with the UE 604 based on the base station-side autonomous configuration 646.

Illustratively, both the base station 602 and the UE 604 may independently predict a beam failure of the current serving beam at a future time step based on respective sets of outputs of the prediction functions 620a, 620b. The respective sets of outputs of the predictions functions 620a, 620b may further indicate a predicted measurement for another beam that offers satisfactory link quality at the future time step. The predicted beam failure may trigger respective autonomous configurations 646a, 646b at the base station 602 and at the UE 604, and both the base station 602 and the UE 604 may perform a beam update procedure to switch from the beam that is predicted to fail to the other beam that is predicted to offer satisfactory link quality in advance of the future time step at which the current beam is predicted to fail. Accordingly, latency and signaling overhead commensurate with generating and transmitting a beam update instruction by the base station 602 may be reduced.

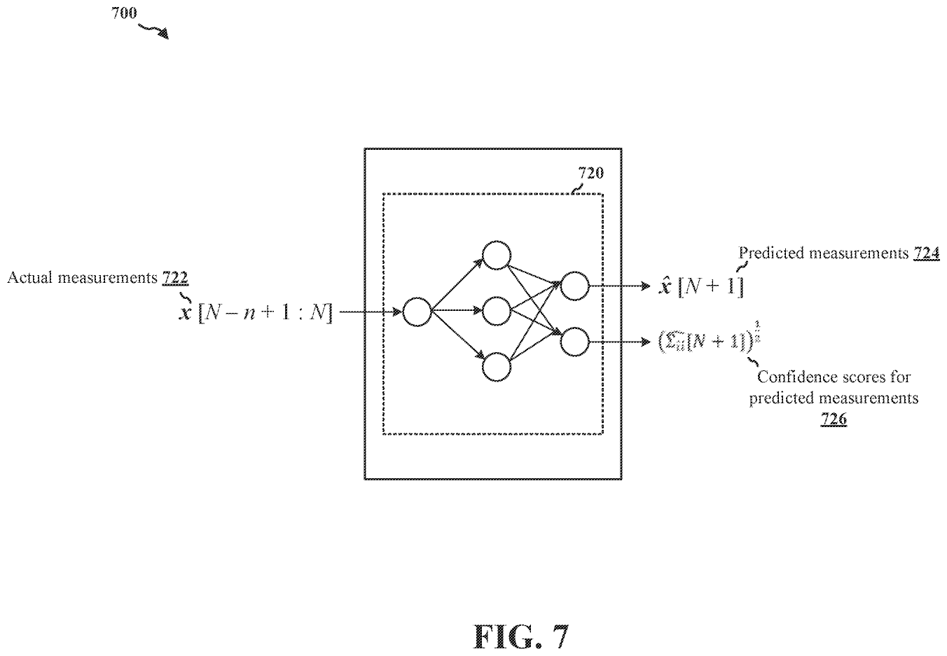

FIG. 7 is a diagram illustrating an example of a prediction function 700 that includes a model 720 configured to receive a set of actual measurements 722 as an input and to provide predicted measurements 724 and confidence scores 726 for the predicted measurements 724 as outputs. The illustrated model 720 may be or may include a neural network, such as an RNN (e.g., an LSTM), CNN, etc., a filtering model, such as an MMSE filtering model, an optimization model, such as a Bayesian optimization model, and so forth. The model 720 may be trained with a negative log likelihood (NLL) loss function, e.g., such that the model is trained to simplify a covariance matrix/in NLL loss as a diagonal matrix.

The model 720 may include may be configured with two output heads, a first of which may be configured to output predicted measurements, such as mean RSRP predictions or mean SNR predictions, and a second of which may be configured to output confidence scores corresponding to the predicted measurements, such as standard deviations, variances, probabilities, and/or likelihoods.

A UE or other network node configured with the prediction function 700 may be configured to track a set of reference signals respectively corresponding to a set of Z beams over a set of n time steps beginning at time N−n+1 and ending at time N. For example, the UE may track Z=24 reference signals (e.g., SSBs or CSI-RSs) over n=8 time steps. An input x may include a set of actual measurements 722 (e.g., RSRP measurements and/or SNR measurements) that may be represented in a Z×1 vector at each of the n time steps.

Based on the input x of actual measurements 722, the model 720 may be trained to output predicted measurements 724, which may be include mean predicted measurements (e.g., mean predicted RSRPs, mean predicted SNRs, etc.) represented as a Z×1 vector. In the Z×1 vector of the predicted measurements 724, each element may represent a mean predicted measurement corresponding to a respective one of the Z beams at a future time step N+1, with each of the Z elements of the vector being predicted from each corresponding element of the Z×1 vectors of the actual measurements 722 over the n past time steps.

Further, the model 720 may be trained to output confidence scores 726 represented as a Z×1 vector having elements that respectively correspond to the Z elements of the predicted measurements 724. In some aspects, the confidence scores 726 may include standard deviations of actual measurements distributed over the n time steps. For example, the confidence scores 726 may include the square root of the diagonal elements in a covariance matrix. The confidence scores 726 may be used as indicators of reliabilities of the predicted measurements 724.

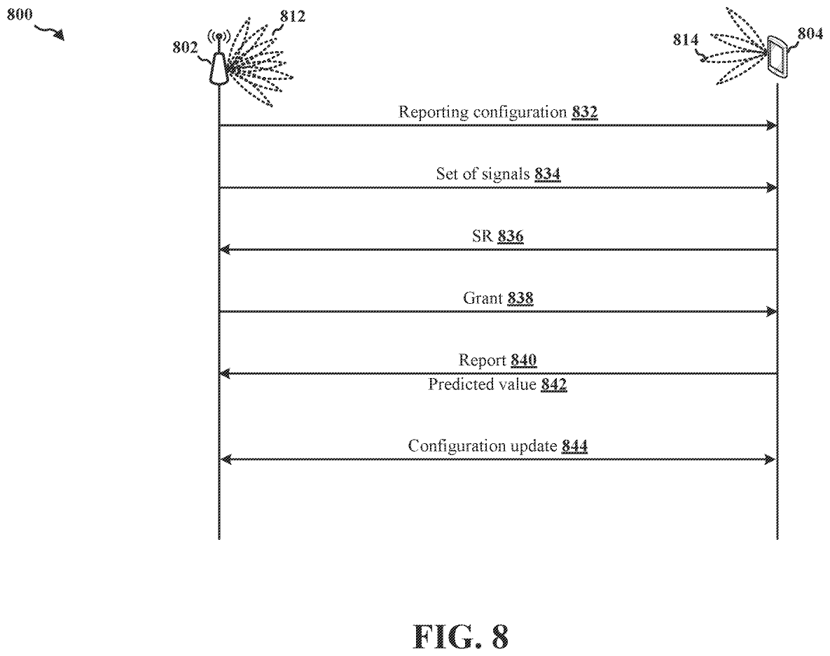

FIG. 8 is a call flow diagram illustrating an example communication flow 800 between a UE 804 that is configured to report a a predicted measurement 842 to a base station 802 based on a configuration 832 provided by the base station. In the illustrated communication flow 800, the UE 804 may be configured with a prediction function, whereas the base station 802 may not use a prediction function (see, e.g., FIG. 6B). Thus, the UE 604 may be configured to report one or more predicted measurements to the base station 802 so that the base station 802 is able to schedule the UE 804 on a beam at a future time step.

The base station 802 may transmit, and the UE 804 may receive, a reporting configuration 832 indicative of information to be included in a report 840. For example, the reporting configuration 832 may indicate that the report 840 should include at least one value of a set of values is measured from at least one signal of a set of signals 834, a first indication that the at least one value of the set of values is measured, at least one predicted value 842 that is based on at least one value of the set of values, and/or a second indication that the at least one predicted value 842 corresponds to a prediction.

The base station 802 may transmit, and the UE 804 may receive, a set of signals 834 respectively corresponding to a set of beams 812 of the base station 802. For example, each of the signals 834 may be an SSB or a CSI-RS transmitted on a respective beam of the set of beams 812.

The UE 804 may determine a set of values respectively corresponding to the set of signals 834 received from the base station 802. In various aspects, each of the set of values may be an RSRP value, an RSRQ value, an SNR value, an SINR value, a CQI value, or an RSSI value. The UE 804 may be configured to identify a respective resource on which each of the set of signals 834 is carried, and the UE 804 may be configured to measure the energy or power on the identified respective resource, e.g., to obtain an RSRP value, and/or measure the energy or power on the identified respective resource that corresponds to one of the set of signals 834 and subtract the measurement from the total energy or power on the identified respective resource, e.g., to obtain an SNR value.

In some aspects, to determine the set of values, the UE 804 may be configured to generate measurement information corresponding to the set of signals 834. For example, the UE 804 may generate a vector for each a plurality of time steps, and the UE 804 may populate elements of each vector with measurements obtained based on the set of signals 834 at a respective time step. In some aspects, the measurement information includes the determined set of values, whereas in some other aspects, the UE 804 may process the measurement information resulting in the set of values.

The UE 804 may determine, based on the set of values respectively corresponding to the set of signals 834 received from the base station 802, at least one predicted value 842, and the at least one predicted value 842 may correspond to at least one beam with which to communicate with the base station 802. The at least one predicted value 842 may be at least one predicted RSRP, at least one predicted RSRQ, at least one predicted SNR, at least one predicted SINR, at least one predicted CQI, or at least one predicted RSSI. In some aspects, the at least one predicted value 842 may be a mean predicted value 842. In some aspects, the UE 804 may predict a respective value at future time step for each measured value corresponding to one of the set of beams 812 over each of a set of past time steps. The UE 804 may plot a distribution of the respective values predicted for a future time step—e.g., the UE 804 may plot a point for a predicted value at the future time step predicted from a measured value at past time step N−n+1, the UE 804 may plot another point for another predicted value at the future time step predicted from another measured value at past time step N−n+2, and so forth. The UE 804 may find the mean of the distribution of the plotted points, which may be the mean predicted value 842 corresponding to the one of the set of beams 812 at the future time step. In some aspects, the UE 804 may determine the at least one predicted value 842 further based on at least one of a battery status of the UE 804, a processor utilization of the UE 804, or a capability of the UE 804.

In some aspects, to determine the at least one predicted value 842, the UE 804 may input the set of values into a function. For example, the function may include at least one of a neural network, a deep-learning model, or a filter-based algorithm.

To determine the at least one predicted value 842, the UE 804 may further obtain the at least one predicted value 842 as output of the function based on inputting the set of values.

When the UE 804 detects that one or more conditions are satisfied, the UE 804 may trigger transmission of a report 840 indicating the predicted value 842. In some aspects, the UE 804 may transmit, and the base station 802 may receive, a scheduling request (SR) 836. Based on the SR 836, the base station 802 may transmit, and the UE 804 may receive, an uplink grant indicating a resource allocation on which to transmit a report.

The UE 804 may transmit, and the base station 802 may receive, a report 840 that includes information indicating the at least one predicted value 842 According to various aspects, the report 840 may further include at least one of at least one of the set of values respectively corresponding to the set of signals 834 transmitted by the base station, a first indication that the at least one of the set of values is measured, the at least one predicted value 842, or a second indication that the at least one predicted value 842 corresponds to a prediction. In some aspects, the information indicating the at least one predicted value 842 may further indicate at least one confidence score. In still other aspects, the report 840 includes time information indicative of a respective time to which each predicted value of the at least one predicted value 842 corresponds. The UE 804 may base the report on the reporting configuration 832.

Upon receiving the report 840, the base station 802 may determine a selected beam of the set of beams 812 based on the at least one predicted value 842. For example, the base station 802 may compare respective predicted values corresponding to each of the set of beams to one another to determine a highest or “best” predicted value corresponding to a selected beam.

The base station 802 may transmit a beam configuration update 844 to the UE 804. The beam configuration update 844 may indicate the selected beam to the UE 804. The UE 804 may receive the beam configuration update 844 and tune antenna panels or arrays in a direction that corresponds or is paired with that of the selected beam.

The base station 802 and the UE 804 may communicate using the selected beam of the set of beams 812 that is based on the information indicating the at least one predicted value 842. For example, the base station 802 may transmit data and/or control information to the UE 804 via the selected beam.

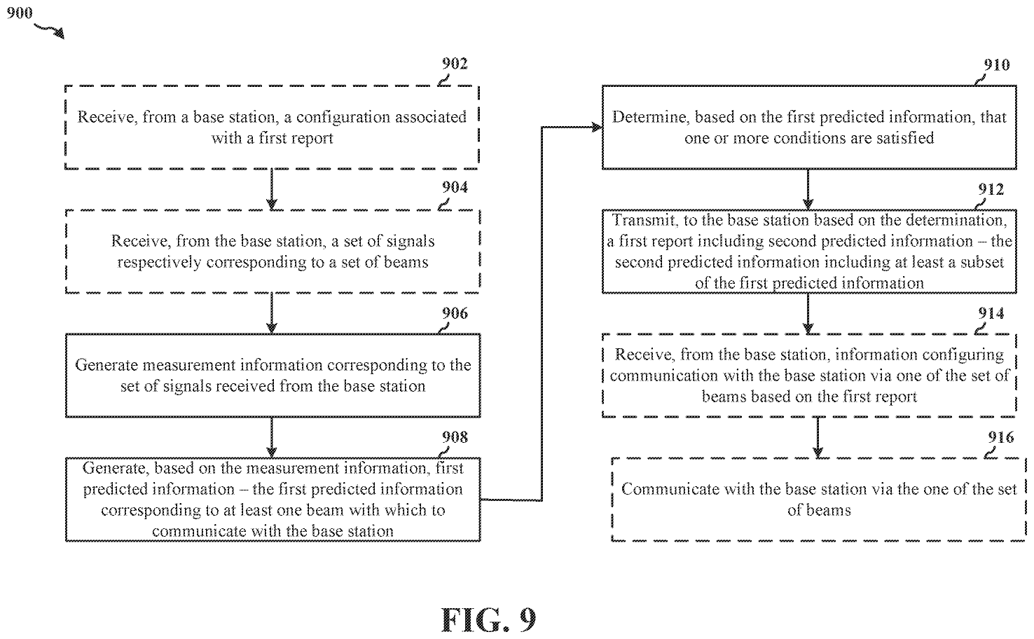

FIG. 9 is a flowchart of a method 900 of wireless communication. The method may be performed by or at a network node, such as a UE (e.g., the UE 104, 350), another wireless communications apparatus (e.g., the apparatus 1102), or one or more components thereof. According to various different aspects, one or more of the illustrated blocks may be omitted, transposed, and/or contemporaneously performed.

At 902, the UE may receive, from a base station, a configuration associated with a first report.

For example, in the context of FIG. 8, the UE 804 may receive, from the base station 802, the reporting configuration 832 indicative of information to be included in the report 840.

At 904, the UE may receive, from the base station, a set of signals respectively corresponding to a set of beams. For example, each of the signals may be an SSB or a CSI-RS transmitted on a respective beam of the set of beams.

For example, in the context of FIG. 8, the UE 804 may receive, from the base station 802, the set of signals 834 respectively corresponding to the set of base station beams 812.

At 906, the UE may generate measurement information corresponding to a set of signals received from the base station. In various aspects, the measurement information may include a set of values, and each of the set of values may be an RSRP value, an RSRQ value, an SNR value, an SINR value, a CQI value, or an RSSI value. The UE may be configured to identify a respective resource on which each of the set of signals is carried, and the UE may be configured to measure the energy or power on the identified respective resource, e.g., to obtain an RSRP value, and/or measure the energy or power on the identified respective resource that corresponds to one of the set of signals and subtract the measurement from the total energy or power on the identified respective resource, e.g., to obtain an SNR value.

For example, in the context of FIG. 8, the UE 804 may determine a set of actual values respectively corresponding to the set of signals 834 received from the base station 802 via the set of beams 812.

At 908, the UE may generate, based on the measurement information, first predicted information, with the first predicted information corresponding to at least one beam with which to communicate with the base station.

For example, in the context of FIG. 7, a UE may obtain the predicted values 724 as output of the prediction function 700 based on inputting the actual measurements 722 into the prediction function 700 having the model 720. For example, in the context of FIG. 8, the UE 804 may determine, based on the set of values respectively corresponding to the set of signals 834 received from the base station 802, at least one predicted value 842, and the at least one predicted value 842 may correspond to at least one beam of the beams 812 with which to communicate with the base station 802.

At 910, the UE may determine, based on the first predicted information, that one or more conditions are satisfied. In some aspects, the one or more conditions are least one of: based on an output of a function, or included in a non-signaled configuration of the first network node. In some other aspects, the one or more conditions are based on at least one of: comparison of the at least one predicted value with a first reporting threshold, at least one output of the function, comparison of the at least one confidence score with a second reporting threshold, comparison of a number of confidence scores of the at least one confidence score that satisfy a confidence threshold before expiry of a timer with a third reporting threshold, comparison of the at least one probability with a fourth reporting threshold, or comparison of a difference between a first predicted value of the at least one predicted value and a second predicted value of the at least one predicted value with a fifth reporting threshold.

In still another aspect, the one or more conditions include the standard deviation is greater than or less than a threshold. In yet another aspect, the measurement information or the first predicted information includes a failure probability of at least one beam of the set of beams, wherein the one or more conditions include: the failure probability is greater than a threshold.

In further aspects, wherein the one or more conditions include a counter reaching a particular value, wherein the at least one processor is configured to reset, increment, or decrement the counter based on at least one of the measurement information and the first predicted information. In still other aspects, the first predicted information includes at least one predicted value, and wherein a first condition of the one or more conditions is based on at least one of at least one measured error associated with the at least one predicted value or at least one predicted error associated with the at least one predicted value.

For example, the at least one measured error comprises at least one difference between the at least one predicted value and at least one measured value that corresponds to a same beam as the at least one predicted value, or the at least one predicted error comprises at least one of at least one standard deviation, at least one variance, at least one probability, or at least one likelihood. In some aspects, the first condition is based on a maximum measured error of the at least one measured error in comparison with a reporting threshold, and wherein the maximum measured error corresponds to a beam of the set of beams.

In some aspects, the first condition is based on an average measured error across the at least one measured error in comparison with a reporting threshold. In some aspects, the first predicted information includes at least one predicted value, and wherein the first report includes at least one of: at least one index of at least one output of a function used to determine the at least one predicted value, at least one measured value corresponding to the at least one beam to which the at least one predicted value corresponds, or at least one input of the function used to determine the at least one predicted value.

In still other aspects, the first predicted information includes at least one predicted value, and wherein the one or more conditions comprises at least one of: a respective condition for each respective output port of a plurality of output ports of a function used to determine the at least one predicted value; or a same condition for all of the plurality of output ports of the function. In still other aspects, the at one or more conditions are based on at least one of: at least two conditions specific to at least two of the plurality of output ports that are of a different type, at least two thresholds specific to at least two of the plurality of output ports that are different, a maximum predicted value of the at least one predicted value across the plurality of output ports, a minimum predicted value of the at least one predicted value across the plurality of output ports, or an average predicted value of the at least one predicted value across the plurality of output ports.

In some aspects, the measurement information includes first measurement information corresponding to a first signal of the set of signals, and wherein the one or more conditions include at least one of: the first measurement information is less than a first threshold; the first measurement information is less than the first threshold by a first threshold amount; the first measurement information is greater than a second threshold; or the first measurement information is greater than the first threshold by a second threshold amount. In one aspect, the first signal corresponds to a serving beam of the set of beams or a non-serving beam of the set of beams. In another aspect, the first measurement information is a first RSRP value corresponding to the first signal. In still another aspect, the measurement information includes a standard deviation corresponding to a plurality of RSRP values.

For example, in the context of FIG. 8, the UE 804 may determine, based on the first predicted information 842, that one or more conditions are satisfied.

At 912, the UE may transmit, to the base station based on the determination, a first report including second predicted information, with the second predicted information including at least a subset of the first predicted information. In some aspects, at least one of the transmission of the first report or the second predicted information may be based on the configuration received from the base station.

In some aspects, the UE may transmit UCI including the first report on a periodic resource or a semi-persistent resource (SPS); or transmit a MAC control element (CE) (MAC-CE) including the first report. For example, the periodic resource may be on a PUCCH or the SPS resource is on the PUCCH or a PUSCH. In some other aspects, the periodic resource or the SPS resource is shared with a second report, and the second report is one of: multiplexed with the first report on the one of the periodic resource or the SPS resource, or unscheduled on the one of the periodic resource or the SPS resource based a first priority associated with the first report and a second priority associated with the second report.

According to various aspects, the report may further include at least one of: at least one ID associated with the set of signals, at least one transmission configuration indicator (TCI) state, at least one index of an output of a function used to determine the first predicted information, at least one predicted reference signal received power (RSRP) value, at least one predicted signal-to-noise ratio (SNR) value, at least one confidence score associated with the first predicted information, or at least one predicted value and at least one of: a probability or a likelihood that the at least one predicted value will fall below a threshold, or at least one timestamp associated with the at least one predicted value. In some other aspects, the first report includes non-predicted information, wherein the non-predicted information is associated with at least one of: the measurement information or one or more signals of the set of signal.

For example, in the context of FIG. 8, the UE 804 may transmit, to the base station 802 when the at least one condition is satisfied, a report 840 that includes information indicating the at least one predicted value 842.

At 914, the UE may receive, from the base station, information configuring communication with the base station via one of the set of beams based on the first report. For example, in the context of FIG. 8, the UE 804 may receive, from the base station 802, the configuration update 844 configuring communication with the base station 802 via one of the set of beams 812 based on the first report 840.

At 916, the UE may communicate with the base station via the one of the set of beams. For example, the UE may receive data and/or control information via the one of the set of the beams. For example, in the context of FIG. 8, the UE 804 may communicate with the base station 802 via the one of the set of beams 812.

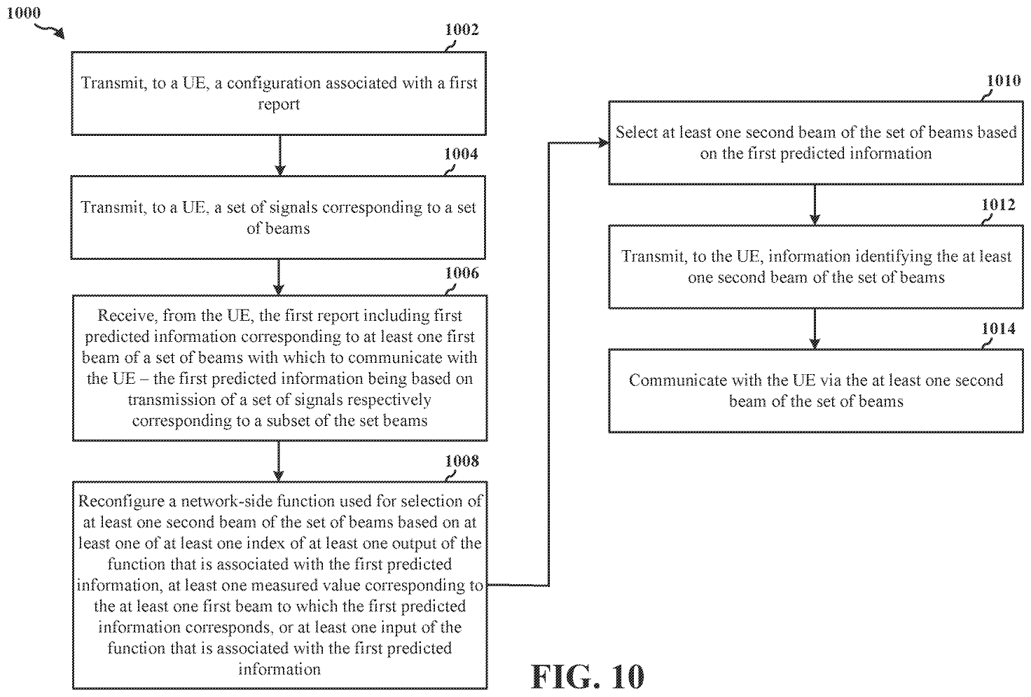

FIG. 10 is a flowchart of a method 1000 of wireless communication. The method may be performed by or at a network node, such as a base station (e.g., the base station 102/180, 310), another wireless communications apparatus (e.g., the apparatus 1202), or one or more components thereof. According to various different aspects, one or more of the illustrated blocks may be omitted, transposed, and/or contemporaneously performed.

At 1002, the base station may transmit, to a UE, a configuration associated with a first report. The configuration may indicate information to be included the report.

For example, in the context of FIG. 8, the base station 802 may transmit, to the UE 804, the reporting configuration 832 indicative of information to be included in the report 840.

At 1004, the base station may transmit, to the UE, a set of signals respectively corresponding to a set of beams. For example, each of the signals may be an SSB or a CSI-RS transmitted on a respective beam of the set of beams.

For example, in the context of FIG. 8, the base station 802 may transmit, to the UE 804, the set of signals 834 respectively corresponding to the set of base station beams 812.

At 1006, the base station may receive, from the UE, a first report including first predicted information corresponding to at least one first beam of a set of beams with which to communicate with the UE, with the first predicted information being based on transmission of a set of signals respectively corresponding to a subset of the set beams. In some aspects, the base station may receive uplink control information (UCI) including the first report on a periodic resource or a semi-persistent resource (SPS); or receive a medium access control (MAC) control element (CE) (MAC-CE) including the first report. In some aspects, the periodic resource is on a physical uplink control channel (PUCCH) or the SPS resource is on the PUCCH or a physical uplink shared channel (PUSCH). In some aspects, the periodic resource or the SPS resource is shared with a second report, and the second report is one of: multiplexed with the first report on the one of the periodic resource or the SPS resource, or unscheduled on the one of the periodic resource or the SPS resource based a first priority associated with the first report and a second priority associated with the second report.

In some aspects, the first report includes at least one of: at least one identifier (ID) associated with the set of signals, at least one transmission configuration indicator (TCI) state, at least one index of an output of a function associated with the first predicted information, at least one predicted reference signal received power (RSRP) value, at least one predicted signal-to-noise ratio (SNR) value, at least one confidence score associated with the first predicted information, or at least one predicted value and at least one of: a probability or a likelihood that the at least one predicted value will fall below a threshold, or at least one timestamp associated with the at least one predicted value.

In some aspects, the first report includes non-predicted information, wherein the non-predicted information is associated with at least one of: the measurement information or one or more signals of the set of signals. In some aspects, the first predicted information includes at least one predicted value and at least one of: at least one measured error associated with the at least one predicted value, or at least one predicted error associated with the at least one predicted value. In some aspects, at least one of: the at least one measured error comprises at least one difference between the at least one predicted value and at least one measured value that corresponds to a same beam as the at least one predicted value, or the at least one predicted error comprises at least one of at least one standard deviation, at least one variance, at least one probability, or at least one likelihood.

In some aspects, the at least one measured error comprises at least one maximum measured error that corresponds to a beam of the set of beams. In some aspects, the at least one measured error comprises at least one average measured error that corresponds to at least two beams of the set of beams. In some aspects, the first report further comprises at least one of: at least one index of at least one output of a function that is associated with the first predicted information, at least one measured value corresponding to the at least one beam to which the first predicted information corresponds, or at least one input of the function that is associated with the first predicted information.

For example, in the context of FIG. 8, the base station 802 may receive, from the UE 804, a report 840 that includes information indicating the at least one confidence score 844 that is associated with on the at least one predicted value 842.

At 1008, the base station may reconfigure a network-side function used for selection of at least one second beam of the set of beams based on at least one of at least one index of at least one output of the function that is associated with the first predicted information, at least one measured value corresponding to the at least one first beam to which the first predicted information corresponds, or at least one input of the function that is associated with the first predicted information.

At 1010, the base station may select at least one second beam of the set of beams based on the first predicted information. For example, the base station may compare respective predicted values corresponding to each of the set of beams to one another to determine a highest or “best” predicted value corresponding to a beam, which the base station may then configure for communication with the UE. In some aspects, the base station may schedule a set of resources on which to communicate with the UE based on the first predicted information.

For example, in the context of FIG. 8, the base station 802 may determine a selected beam of the set of beams 812 based on the information indicating the at least one confidence score 844 that is associated with on the at least one predicted value 842.

At 1012, the base station may transmit, to the UE, information identifying the at least one second beam of the set of beams. For example, in the context of FIG. 8, the base station 802 may transmit, to the UE 804, the configuration update 844 identifying the at least one second beam of the set of beams.

At 1014, the base station may communicate with the second network node via the at least one second beam of the set of beams. For example, the base station may transmit data and/or control information to the UE via the selected beam.

For example, in the context of FIG. 8, the base station 802 may communicate with the UE 804 via the at least one second beam of the set of beams 812.

Clause 1: A method of wireless communication, comprising: generating measurement information corresponding to a set of signals received from a base station, wherein the set of signals corresponds to a set of beams; generating, based on the measurement information, first predicted information, wherein the first predicted information corresponds to at least one beam with which to communicate with the base station; determining, based on the first predicted information, that one or more conditions are satisfied; and transmitting, to the base station based on the determination, a first report including second predicted information, wherein the second predicted information includes the first predicted information or the second predicted information is a subset of the first predicted information.

Clause 2: The method of clause 1, further comprising: receiving, from the base station, a configuration associated with the first report, wherein at least one of the transmission of the first report or the second predicted information is based on the configuration.

Clause 3: The method of any of clauses 1 to 2, wherein, to transmit the first report, the at least one processor is configured to: transmit uplink control information (UCI) including the first report on a periodic resource or a semi-persistent resource (SPS); or transmit a medium access control (MAC) control element (CE) (MAC-CE) including the first report.

Clause 4: The method of any of clauses 1 to 3, wherein the one or more conditions are least one of: based on an output of a function, or included in a non-signaled configuration of the method.

Clause 5: may be the method of any of clauses 1 to 4, wherein the periodic resource is on a physical uplink control channel (PUCCH) or the SPS resource is on the PUCCH or a physical uplink shared channel (PUSCH).

Clause 6 may be the method of clause 3, wherein the periodic resource or the SPS resource is shared with a second report, and the second report is one of: multiplexed with the first report on the one of the periodic resource or the SPS resource, or unscheduled on the one of the periodic resource or the SPS resource based a first priority associated with the first report and a second priority associated with the second report.

Clause 7: The method of any of clauses 1 to 6, wherein the first report includes at least one of: at least one identifier (ID) associated with the set of signals, at least one transmission configuration indicator (TCI) state, at least one index of an output of a function used to determine the first predicted information, at least one predicted reference signal received power (RSRP) value, at least one predicted signal-to-noise ratio (SNR) value, at least one confidence score associated with the first predicted information, or at least one predicted value and at least one of: a probability or a likelihood that the at least one predicted value will fall below a threshold, or at least one timestamp associated with the at least one predicted value.

Clause 8: The method of clause 7, wherein the one or more conditions are based on at least one of: comparison of the at least one predicted value with a first reporting threshold, at least one output of the function, comparison of the at least one confidence score with a second reporting threshold, comparison of a number of confidence scores of the at least one confidence score that satisfy a confidence threshold before expiry of a timer with a third reporting threshold, comparison of the at least one probability with a fourth reporting threshold, or comparison of a difference between a first predicted value of the at least one predicted value and a second predicted value of the at least one predicted value with a fifth reporting threshold.

Clause 9: The method of any of clauses 1 to 8, wherein the measurement information includes first measurement information corresponding to a first signal of the set of signals, and wherein the one or more conditions include at least one of: the first measurement information is less than a first threshold; the first measurement information is less than the first threshold by a first threshold amount; the first measurement information is greater than a second threshold; or the first measurement information is greater than the first threshold by a second threshold amount.

Clause 10: The method of any of clauses 1 to 9, wherein the first signal corresponds to a serving beam of the set of beams or a non-serving beam of the set of beams.

Clause 11: The method of any of clauses 1 to 10, wherein the first measurement information is a first RSRP value corresponding to the first signal.

Clause 12: The method of any of clauses 1 to 11, wherein the measurement information includes a standard deviation corresponding to a plurality of RSRP values, and wherein the one or more conditions include the standard deviation is greater than or less than a threshold.

Clause 13: The method of any of clauses 1 to 12, wherein the measurement information or the first predicted information includes a failure probability of at least one beam of the set of beams, wherein the one or more conditions include: the failure probability is greater than a threshold.

Clause 14: The method of any of clauses 1 to 13, wherein the one or more conditions include: a counter reaching a particular value, further comprising reset, increment, or decrement the counter based on at least one of the measurement information and the first predicted information.

Clause 15: The method of any of clauses 1 to 14, wherein the first report includes non-predicted information, wherein the non-predicted information is associated with at least one of: the measurement information or one or more signals of the set of signals.

Clause 16: The method of any of clauses 1 to 15, wherein the first predicted information includes at least one predicted value, and wherein a first condition of the one or more conditions is based on at least one of at least one measured error associated with the at least one predicted value or at least one predicted error associated with the at least one predicted value.

Clause 17: The method of any of clauses 1 to 16, wherein at least one of: the at least one measured error comprises at least one difference between the at least one predicted value and at least one measured value that corresponds to a same beam as the at least one predicted value, or the at least one predicted error comprises at least one of at least one standard deviation, at least one variance, at least one probability, or at least one likelihood.

Clause 18: The method of clause 17, wherein the first condition is based on a maximum measured error of the at least one measured error in comparison with a reporting threshold, and wherein the maximum measured error corresponds to a beam of the set of beams.

Clause 19: The method of clause 17, wherein the first condition is based on an average measured error across the at least one measured error in comparison with a reporting threshold.

Clause 20: The method of clause 17, wherein the first predicted information includes at least one predicted value, and wherein the first report includes at least one of: at least one index of at least one output of a function used to determine the at least one predicted value, at least one measured value corresponding to the at least one beam to which the at least one predicted value corresponds, or at least one input of the function used to determine the at least one predicted value.

Clause 21: The method of any of clauses 1 to 20, wherein the first predicted information includes at least one predicted value, and wherein the one or more conditions comprises at least one of: a respective condition for each respective output port of a plurality of output ports of a function used to determine the at least one predicted value; or a same condition for all of the plurality of output ports of the function.

Clause 22: The method of clause 21, wherein the at one or more conditions are based on at least one of: at least two conditions specific to at least two of the plurality of output ports that are of a different type, at least two thresholds specific to at least two of the plurality of output ports that are different, a maximum predicted value of the at least one predicted value across the plurality of output ports, a minimum predicted value of the at least one predicted value across the plurality of output ports, or an average predicted value of the at least one predicted value across the plurality of output ports.

Clause 23: The method of any of clauses 1 to 22, further comprising: receiving, from the base station, information configuring communication with the base station via one of the set of beams based on the first report; and communicating with the base station via the one of the set of beams.

Clause 24: A method of wireless communication, comprising: receiving, from a UE, a first report including first predicted information corresponding to at least one first beam of a set of beams with which to communicate with the UE, the first predicted information being based on a set of signals respectively corresponding to a subset of the set beams; determining at least one second beam of the set of beams based on the first predicted information; transmitting, to the UE, information identifying the at least one second beam of the set of beams; and communicating with the UE via the at least one second beam of the set of beams.

Clause 25: The method of clause 24, further comprising: transmitting, to the UE, a configuration associated with the first report, wherein at least one of the reception of the first report or the first predicted information is based on the configuration.

Clause 26: The method of any of clauses 24 to 25, wherein, to receive the first report, the at least one processor is configured to: receive uplink control information (UCI) including the first report on a periodic resource or a semi-persistent resource (SPS); or receive a medium access control (MAC) control element (CE) (MAC-CE) including the first report.

Clause 27: The method of clause 26, wherein the periodic resource is on a physical uplink control channel (PUCCH) or the SPS resource is on the PUCCH or a physical uplink shared channel (PUSCH).

Clause 28: The method of clause 26, wherein the periodic resource or the SPS resource is shared with a second report, and the second report is one of: multiplexed with the first report on the one of the periodic resource or the SPS resource, or unscheduled on the one of the periodic resource or the SPS resource based a first priority associated with the first report and a second priority associated with the second report.

Clause 29: The method of any of clauses 24 to 28, wherein the first report includes at least one of: at least one identifier (ID) associated with the set of signals, at least one transmission configuration indicator (TCI) state, at least one index of an output of a function associated with the first predicted information, at least one predicted reference signal received power (RSRP) value, at least one predicted signal-to-noise ratio (SNR) value, at least one confidence score associated with the first predicted information, or at least one predicted value and at least one of: a probability or a likelihood that the at least one predicted value will fall below a threshold, or at least one timestamp associated with the at least one predicted value.

Clause 30: The method of any of clauses 24 to 29, wherein the first report includes non-predicted information, wherein the non-predicted information is associated with at least one of: the measurement information or one or more signals of the set of signals.

Clause 31: The method of any of clauses 24 to 30, wherein the first predicted information includes at least one predicted value and at least one of: at least one measured error associated with the at least one predicted value, or at least one predicted error associated with the at least one predicted value.

Clause 32: The method of clause 31, wherein at least one of: the at least one measured error comprises at least one difference between the at least one predicted value and at least one measured value that corresponds to a same beam as the at least one predicted value, or the at least one predicted error comprises at least one of at least one standard deviation, at least one variance, at least one probability, or at least one likelihood.

Clause 33: The method of clause 31, wherein the at least one measured error comprises at least one maximum measured error that corresponds to a beam of the set of beams.

Clause 34: The method of clause 31, wherein the at least one measured error comprises at least one average measured error that corresponds to at least two beams of the set of beams.

Clause 35: The method of any of clauses 24 to 34, wherein the first report further comprises at least one of: at least one index of at least one output of a function that is associated with the first predicted information, at least one measured value corresponding to the at least one beam to which the first predicted information corresponds, or at least one input of the function that is associated with the first predicted information.

Clause 36: The method of clause 35, further comprising: reconfiguring a network-side function used for selection of the at least one second beam of the set of beams based on the at least one of the at least one index of the at least one output, the at least one measured value, or the at least one input.

Clause 37: The method of any of clauses 24 to 36, further comprising scheduling a set of resources on which to communicate with the UE based on the first predicted information, wherein the communication with the UE is further based on the schedule of the set of resources.

Clause 38: A first network node for wireless communication, comprising: a memory;

and at least one processor coupled to the memory, wherein the at least one processor is configured to: generate measurement information corresponding to a set of signals received from a second network node, wherein the set of signals corresponds to a set of beams; generate, based on the measurement information, first predicted information, wherein the first predicted information corresponds to at least one beam with which to communicate with the second network node; determine, based on the first predicted information, that one or more conditions are satisfied; and transmit, to the second network node based on the determination, a first report including second predicted information, wherein the second predicted information includes the first predicted information or the second predicted information is a subset of the first predicted information.

Clause 39: The first network node of clause 38, wherein the at least one processor is further configured to receive, from the second network node, a configuration associated with the first report, wherein at least one of the transmission of the first report or the second predicted information is based on the configuration.

Clause 40: The first network node of clause 38, wherein, to transmit the first report, the at least one processor is configured to: transmit uplink control information (UCI) including the first report on a periodic resource or a semi-persistent resource (SPS); or transmit a medium access control (MAC) control element (CE) (MAC-CE) including the first report.

Clause 41: The first network node of clause 40, wherein the periodic resource is on a physical uplink control channel (PUCCH) or the SPS resource is on the PUCCH or a physical uplink shared channel (PUSCH).

Clause 42: The first network node of clause 40, wherein the periodic resource or the SPS resource is shared with a second report, and the second report is one of: multiplexed with the first report on the one of the periodic resource or the SPS resource, or unscheduled on the one of the periodic resource or the SPS resource based a first priority associated with the first report and a second priority associated with the second report.

Clause 43: The first network node of clause 38, wherein the one or more conditions are least one of: based on an output of a function, or included in a non-signaled configuration of the first network node.

Clause 44: The first network node of clause 38, wherein the first report includes at least one of: at least one identifier (ID) associated with the set of signals, at least one transmission configuration indicator (TCI) state, at least one index of an output of a function used to determine the first predicted information, at least one predicted reference signal received power (RSRP) value, at least one predicted signal-to-noise ratio (SNR) value, at least one confidence score associated with the first predicted information, or at least one predicted value and at least one of: a probability or a likelihood that the at least one predicted value will fall below a threshold, or at least one timestamp associated with the at least one predicted value.

Clause 45: The first network node of clause 44, wherein the one or more conditions are based on at least one of: comparison of the at least one predicted value with a first reporting threshold, at least one output of the function, comparison of the at least one confidence score with a second reporting threshold, comparison of a number of confidence scores of the at least one confidence score that satisfy a confidence threshold before expiry of a timer with a third reporting threshold, comparison of the at least one probability with a fourth reporting threshold, or comparison of a difference between a first predicted value of the at least one predicted value and a second predicted value of the at least one predicted value with a fifth reporting threshold.

Clause 46: The first network node of clause 38, wherein the measurement information includes first measurement information corresponding to a first signal of the set of signals, and wherein the one or more conditions include at least one of: the first measurement information is less than a first threshold; the first measurement information is less than the first threshold by a first threshold amount; the first measurement information is greater than a second threshold; or the first measurement information is greater than the first threshold by a second threshold amount.

Clause 47: The first network node of clause 46, wherein the first signal corresponds to a serving beam of the set of beams or a non-serving beam of the set of beams.

Clause 48: The first network node of clause 46, wherein the first measurement information is a first RSRP value corresponding to the first signal.

Clause 49: The first network node of clause 38, wherein the measurement information includes a standard deviation corresponding to a plurality of RSRP values, and wherein the one or more conditions include the standard deviation is greater than or less than a threshold.

Clause 50: The first network node of clause 38, wherein the measurement information or the first predicted information includes a failure probability of at least one beam of the set of beams, wherein the one or more conditions include the failure probability being greater than a threshold.

Clause 51: The first network node of clause 38, wherein the one or more conditions include a counter reaching a particular value, and wherein the at least one processor is configured to reset, increment, or decrement the counter based on at least one of the measurement information and the first predicted information.

Clause 52: The first network node of clause 38, wherein the first report includes non-predicted information, wherein the non-predicted information is associated with at least one of: the measurement information or one or more signals of the set of signals.

Clause 53: The first network node of clause 38, wherein the first predicted information includes at least one predicted value, and wherein a first condition of the one or more conditions is based on at least one of at least one measured error associated with the at least one predicted value or at least one predicted error associated with the at least one predicted value.

Clause 54: The first network node of clause 53, wherein at least one of: the at least one measured error comprises at least one difference between the at least one predicted value and at least one measured value that corresponds to a same beam as the at least one predicted value, or the at least one predicted error comprises at least one of at least one standard deviation, at least one variance, at least one probability, or at least one likelihood.

Clause 55: The first network node of clause 53, wherein the first condition is based on a maximum measured error of the at least one measured error in comparison with a reporting threshold, and wherein the maximum measured error corresponds to a beam of the set of beams.

Clause 56: The first network node of clause 53, wherein the first condition is based on an average measured error across the at least one measured error in comparison with a reporting threshold.

Clause 57: The first network node of clause 53, wherein the first predicted information includes at least one predicted value, and wherein the first report includes at least one of: at least one index of at least one output of a function used to determine the at least one predicted value, at least one measured value corresponding to the at least one beam to which the at least one predicted value corresponds, or at least one input of the function used to determine the at least one predicted value.

Clause 58: The first network node of clause 38, wherein the first predicted information includes at least one predicted value, and wherein the one or more conditions comprises at least one of: a respective condition for each respective output port of a plurality of output ports of a function used to determine the at least one predicted value; or a same condition for all of the plurality of output ports of the function.

Clause 59: The first network node of clause 58, wherein the at one or more conditions are based on at least one of: at least two conditions specific to at least two of the plurality of output ports that are of a different type, at least two thresholds specific to at least two of the plurality of output ports that are different, a maximum predicted value of the at least one predicted value across the plurality of output ports, a minimum predicted value of the at least one predicted value across the plurality of output ports, or an average predicted value of the at least one predicted value across the plurality of output ports.

Clause 60: The first network node of clause 38, wherein the at least one processor is further configured to: receive, from the second network node, information configuring communication with the second network node via one of the set of beams based on the first report; and communicate with the second network node via the one of the set of beams.

Clause 61: A first network node for wireless communication, comprising: a memory; and at least one processor coupled to the memory, wherein the at least one processor is configured to: receive, from a second network node, a first report including first predicted information corresponding to at least one first beam of a set of beams with which to communicate with the second network node, the first predicted information being based on a set of signals respectively corresponding to a subset of the set beams; select at least one second beam of the set of beams based on the first predicted information; transmit, to the second network node, information identifying the at least one second beam of the set of beams; and communicate with the second network node via the at least one second beam of the set of beams.

Clause 62: The first network node of clause 61, wherein the at least one processor is further configured to: transmit, to the second network node, a configuration associated with the first report, wherein at least one of the reception of the first report or the first predicted information is based on the configuration.

Clause 63: The first network node of clause 61, wherein, to receive the first report, the at least one processor is configured to: receive uplink control information (UCI) including the first report on a periodic resource or a semi-persistent resource (SPS); or receive a medium access control (MAC) control element (CE) (MAC-CE) including the first report.

Clause 64: The first network node of clause 63, wherein the periodic resource is on a physical uplink control channel (PUCCH) or the SPS resource is on the PUCCH or a physical uplink shared channel (PUSCH).

Clause 65: The first network node of clause 63, wherein the periodic resource or the SPS resource is shared with a second report, and the second report is one of: multiplexed with the first report on the one of the periodic resource or the SPS resource, or unscheduled on the one of the periodic resource or the SPS resource based a first priority associated with the first report and a second priority associated with the second report.

Clause 66: The first network node of clause 61, wherein the first report includes at least one of: at least one identifier (ID) associated with the set of signals, at least one transmission configuration indicator (TCI) state, at least one index of an output of a function associated with the first predicted information, at least one predicted reference signal received power (RSRP) value, at least one predicted signal-to-noise ratio (SNR) value, at least one confidence score associated with the first predicted information, or at least one predicted value and at least one of: a probability or a likelihood that the at least one predicted value will fall below a threshold, or at least one timestamp associated with the at least one predicted value.

Clause 67: The first network node of clause 61, wherein the first report includes non-predicted information, wherein the non-predicted information is associated with at least one of: the measurement information or one or more signals of the set of signals.

Clause 68: The first network node of clause 61, wherein the first predicted information includes at least one predicted value and at least one of: at least one measured error associated with the at least one predicted value, or at least one predicted error associated with the at least one predicted value.

Clause 69: The first network node of clause 68, wherein at least one of: the at least one measured error comprises at least one difference between the at least one predicted value and at least one measured value that corresponds to a same beam as the at least one predicted value, or the at least one predicted error comprises at least one of at least one standard deviation, at least one variance, at least one probability, or at least one likelihood.

Clause 70: The first network node of clause 68, wherein the at least one measured error comprises at least one maximum measured error that corresponds to a beam of the set of beams.

Clause 71: The first network node of clause 68, wherein the at least one measured error comprises at least one average measured error that corresponds to at least two beams of the set of beams.

Clause 72: The first network node of clause 61, wherein the first report further comprises at least one of: at least one index of at least one output of a function that is associated with the first predicted information, at least one measured value corresponding to the at least one beam to which the first predicted information corresponds, or at least one input of the function that is associated with the first predicted information.

Clause 73: The first network node of clause 72, wherein the at least one processor is further configured to reconfigure a network-side function used for selection of the at least one second beam of the set of beams based on the at least one of the at least one index of the at least one output, the at least one measured value, or the at least one input.

Clause 74: The first network node of clause 61, wherein the at least one processor is further configured to schedule a set of resources on which to communicate with the second network node based on the first predicted information, wherein the communication with the second network node is further based on the schedule of the set of resources.

Clause 75: A first network node for wireless communication, comprising: a memory; and at least one processor coupled to the memory, wherein the at least one processor is configured to: generate measurement information corresponding to a set of signals received from a second network node, wherein the set of signals corresponds to a set of beams; generate, based on the measurement information, first predicted information, wherein the first predicted information corresponds to at least one beam with which to communicate with the second network node; determine, based on the first predicted information, that one or more conditions are satisfied; and transmit, to the second network node based on the determination, a first report including second predicted information, wherein the second predicted information includes the first predicted information or the second predicted information is a subset of the first predicted information.

Clause 76: The first network node of clause 75, wherein the at least one processor is further configured to receive, from the second network node, a configuration associated with the first report, wherein at least one of the transmission of the first report or the second predicted information is based on the configuration.

Clause 77: The first network node of any of clauses 75 and 76, wherein to transmit the first report, the at least one processor is configured to: transmit uplink control information (UCI) including the first report on a periodic resource or a semi-persistent resource (SPS); or transmit a medium access control (MAC) control element (CE) (MAC-CE) including the first report.

Clause 78: The first network node of clause 77, wherein the periodic resource is on a physical uplink control channel (PUCCH) or the SPS resource is on the PUCCH or a physical uplink shared channel (PUSCH).

Clause 79: The first network node of any of clauses 77 and 78, wherein the periodic resource or the SPS resource is shared with a second report, and the second report is one of: multiplexed with the first report on the one of the periodic resource or the SPS resource, or unscheduled on the one of the periodic resource or the SPS resource based a first priority associated with the first report and a second priority associated with the second report.

Clause 80: The first network node of any of clauses 75-79, wherein the one or more conditions are least one of: based on an output of a function, or included in a non-signaled configuration of the first network node.

Clause 81: The first network node of any of clauses 75-80, wherein the first report includes at least one of: at least one identifier (ID) associated with the set of signals, at least one transmission configuration indicator (TCI) state, at least one index of an output of a function used to determine the first predicted information, at least one predicted reference signal received power (RSRP) value, at least one predicted signal-to-noise ratio (SNR) value, at least one confidence score associated with the first predicted information, or at least one predicted value and at least one of:a probability or a likelihood that the at least one predicted value will fall below a threshold, or at least one timestamp associated with the at least one predicted value.

Clause 82: The first network node of clause 81, wherein the one or more conditions are based on at least one of: comparison of the at least one predicted value with a first reporting threshold, at least one output of the function, comparison of the at least one confidence score with a second reporting threshold, comparison of a number of confidence scores of the at least one confidence score that satisfy a confidence threshold before expiry of a timer with a third reporting threshold, comparison of the at least one probability with a fourth reporting threshold, or comparison of a difference between a first predicted value of the at least one predicted value and a second predicted value of the at least one predicted value with a fifth reporting threshold.

Clause 83: The first network node of any of clauses 75-82, wherein the measurement information includes first measurement information corresponding to a first signal of the set of signals, and wherein the one or more conditions include at least one of: the first measurement information is less than a first threshold; the first measurement information is less than the first threshold by a first threshold amount; the first measurement information is greater than a second threshold; or the first measurement information is greater than the first threshold by a second threshold amount.

Clause 84: The first network node of clause 83, wherein the first signal corresponds to a serving beam of the set of beams or a non-serving beam of the set of beams.

Clause 85: The first network node of any of clauses 83 and 84, wherein the first measurement information is a first RSRP value corresponding to the first signal.

Clause 86: The first network node of any of clauses 75-85, wherein the measurement information includes a standard deviation corresponding to a plurality of RSRP values, and wherein the one or more conditions include the standard deviation is greater than or less than a threshold.

Clause 87: The first network node of any of clauses 75-86, wherein the measurement information or the first predicted information includes a failure probability of at least one beam of the set of beams, wherein the one or more conditions include the failure probability being greater than a threshold.

Clause 88: The first network node of any of clauses 75-87, wherein the one or more conditions include a counter reaching a particular value, and wherein the at least one processor is configured to reset, increment, or decrement the counter based on at least one of the measurement information and the first predicted information.

Clause 89: The first network node of any of clauses 75-88, wherein the first report includes non-predicted information, wherein the non-predicted information is associated with at least one of: the measurement information or one or more signals of the set of signals.

Clause 90: The first network node of any of clauses 75-89, wherein the first predicted information includes at least one predicted value, and wherein a first condition of the one or more conditions is based on at least one of at least one measured error associated with the at least one predicted value or at least one predicted error associated with the at least one predicted value.

Clause 91: The first network node of clause 90, wherein at least one of: the at least one measured error comprises at least one difference between the at least one predicted value and at least one measured value that corresponds to a same beam as the at least one predicted value, or the at least one predicted error comprises at least one of at least one standard deviation, at least one variance, at least one probability, or at least one likelihood.

Clause 92: The first network node of any of clauses 90 and 91, wherein the first condition is based on a maximum measured error of the at least one measured error in comparison with a reporting threshold, and wherein the maximum measured error corresponds to a beam of the set of beams.

Clause 93: The first network node of any of clauses 90-92, wherein the first condition is based on an average measured error across the at least one measured error in comparison with a reporting threshold.

Clause 94: The first network node of any of clauses 90-93, wherein the first predicted information includes at least one predicted value, and wherein the first report includes at least one of: at least one index of at least one output of a function used to determine the at least one predicted value, at least one measured value corresponding to the at least one beam to which the at least one predicted value corresponds, or at least one input of the function used to determine the at least one predicted value.

Clause 95: The first network node of any of clauses 75-94, wherein the first predicted information includes at least one predicted value, and wherein the one or more conditions comprises at least one of: a respective condition for each respective output port of a plurality of output ports of a function used to determine the at least one predicted value; or a same condition for all of the plurality of output ports of the function.

Clause 96: The first network node of clause 95, wherein the at one or more conditions are based on at least one of: at least two conditions specific to at least two of the plurality of output ports that are of a different type, at least two thresholds specific to at least two of the plurality of output ports that are different, a maximum predicted value of the at least one predicted value across the plurality of output ports, a minimum predicted value of the at least one predicted value across the plurality of output ports, or an average predicted value of the at least one predicted value across the plurality of output ports.

Clause 97: The first network node of any of clauses 75-96 wherein the at least one processor is further configured to: receive, from the second network node, information configuring communication with the second network node via one of the set of beams based on the first report; and communicate with the second network node via the one of the set of beams.

Clause 98: A first network node for wireless communication, comprising: a memory; and at least one processor coupled to the memory, wherein the at least one processor is configured to: receive, from a second network node, a first report including first predicted information corresponding to at least one first beam of a set of beams with which to communicate with the second network node, the first predicted information being based on a set of signals respectively corresponding to a subset of the set beams; select at least one second beam of the set of beams based on the first predicted information; transmit, to the second network node, information identifying the at least one second beam of the set of beams; and communicate with the second network node via the at least one second beam of the set of beams.

Clause 99: The first network node of clause 98, wherein the at least one processor is further configured to: transmit, to the second network node, a configuration associated with the first report, wherein at least one of the reception of the first report or the first predicted information is based on the configuration.

Clause 100: The first network node of any of clauses 98 and 99, wherein, to receive the first report, the at least one processor is configured to: receive uplink control information (UCI) including the first report on a periodic resource or a semi-persistent resource (SPS); or receive a medium access control (MAC) control element (CE) (MAC-CE) including the first report.

Clause 101: The first network node of clause 100, wherein the periodic resource is on a physical uplink control channel (PUCCH) or the SPS resource is on the PUCCH or a physical uplink shared channel (PUSCH).

Clause 102: The first network node of any of clauses 100 and 101, wherein the periodic resource or the SPS resource is shared with a second report, and the second report is one of: multiplexed with the first report on the one of the periodic resource or the SPS resource, or unscheduled on the one of the periodic resource or the SPS resource based a first priority associated with the first report and a second priority associated with the second report.

Clause 103: The first network node of any of clauses 98-102, wherein the first report includes at least one of: at least one identifier (ID) associated with the set of signals, at least one transmission configuration indicator (TCI) state, at least one index of an output of a function associated with the first predicted information, at least one predicted reference signal received power (RSRP) value, at least one predicted signal-to-noise ratio (SNR) value, at least one confidence score associated with the first predicted information, or at least one predicted value and at least one of: a probability or a likelihood that the at least one predicted value will fall below a threshold, or at least one timestamp associated with the at least one predicted value.

Clause 104: The first network node of any of clauses 98-103, wherein the first report includes non-predicted information, wherein the non-predicted information is associated with at least one of: the measurement information or one or more signals of the set of signals.

Clause 105: The first network node of any of clauses 98-104, wherein the first predicted information includes at least one predicted value and at least one of: at least one measured error associated with the at least one predicted value, or at least one predicted error associated with the at least one predicted value.

Clause 106: The first network node of clause 105, wherein at least one of: the at least one measured error comprises at least one difference between the at least one predicted value and at least one measured value that corresponds to a same beam as the at least one predicted value, or the at least one predicted error comprises at least one of at least one standard deviation, at least one variance, at least one probability, or at least one likelihood.

Clause 107: The first network node of any of clauses 105 and 106, wherein the at least one measured error comprises at least one maximum measured error that corresponds to a beam of the set of beams.

Clause 108: The first network node of any of clauses 105-107, wherein the at least one measured error comprises at least one average measured error that corresponds to at least two beams of the set of beams.

Clause 109: The first network node of any of clauses 98-108, wherein the first report further comprises at least one of: at least one index of at least one output of a function that is associated with the first predicted information, at least one measured value corresponding to the at least one beam to which the first predicted information corresponds, or at least one input of the function that is associated with the first predicted information.

Clause 110: The first network node of clause 109, wherein the at least one processor is further configured to reconfigure a network-side function used for selection of the at least one second beam of the set of beams based on the at least one of the at least one index of the at least one output, the at least one measured value, or the at least one input.

Clause 111: The first network node of any of clauses 98-110, wherein the at least one processor is further configured to schedule a set of resources on which to communicate with the second network node based on the first predicted information, wherein the communication with the second network node is further based on the schedule of the set of resources.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As yet another example, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As still another example, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

What is claimed is:

1. A first network node for wireless communication, comprising:
a memory; and
at least one processor coupled to the memory, wherein the at least one processor is configured to:
generate measurement information corresponding to a set of signals received from a second network node, wherein the set of signals corresponds to a set of beams;
generate, based on the measurement information, first predicted information, wherein the first predicted information corresponds to at least one beam with which to communicate with the second network node;
determine, based on the first predicted information, that one or more conditions are satisfied; and
transmit, to the second network node based on the determination, a first report including second predicted information, wherein the second predicted information includes the first predicted information or the second predicted information is a subset of the first predicted information.

2. The first network node of claim 1, wherein the at least one processor is further configured to receive, from the second network node, a configuration associated with the first report, wherein at least one of the transmission of the first report or the second predicted information is based on the configuration.

3. The first network node of claim 1, wherein, to transmit the first report, the at least one processor is configured to:
transmit uplink control information (UCI) including the first report on a periodic resource or a semi-persistent resource (SPS); or
transmit a medium access control (MAC) control element (CE) (MAC-CE) including the first report.

4. The first network node of claim 3, wherein the periodic resource is on a physical uplink control channel (PUCCH) or the SPS resource is on the PUCCH or a physical uplink shared channel (PUSCH).

5. The first network node of claim 3, wherein the periodic resource or the SPS resource is shared with a second report, and the second report is one of:
multiplexed with the first report on the one of the periodic resource or the SPS resource, or
unscheduled on the one of the periodic resource or the SPS resource based a first priority associated with the first report and a second priority associated with the second report.

6. The first network node of claim 1, wherein the one or more conditions are least one of:
based on an output of a function, or
included in a non-signaled configuration of the first network node.

7. The first network node of claim 1, wherein the first report includes at least one of:
at least one identifier (ID) associated with the set of signals,
at least one transmission configuration indicator (TCI) state,
at least one index of an output of a function used to determine the first predicted information,
at least one predicted reference signal received power (RSRP) value,
at least one predicted signal-to-noise ratio (SNR) value,
at least one confidence score associated with the first predicted information, or at least one predicted value and at least one of:
a probability or a likelihood that the at least one predicted value will fall below a threshold, or
at least one timestamp associated with the at least one predicted value.

8. The first network node of claim 7, wherein the one or more conditions are based on at least one of:
comparison of the at least one predicted value with a first reporting threshold,
at least one output of the function,
comparison of the at least one confidence score with a second reporting threshold,
comparison of a number of confidence scores of the at least one confidence score that satisfy a confidence threshold before expiry of a timer with a third reporting threshold,
comparison of the at least one probability with a fourth reporting threshold, or
comparison of a difference between a first predicted value of the at least one predicted value and a second predicted value of the at least one predicted value with a fifth reporting threshold.

9. The first network node of claim 1, wherein the measurement information includes first measurement information corresponding to a first signal of the set of signals, and wherein the one or more conditions include at least one of:
the first measurement information is less than a first threshold;
the first measurement information is less than the first threshold by a first threshold amount;
the first measurement information is greater than a second threshold; or
the first measurement information is greater than the first threshold by a second threshold amount.

10. The first network node of claim 9, wherein the first signal corresponds to a serving beam of the set of beams or a non-serving beam of the set of beams.

11. The first network node of claim 9, wherein the first measurement information is a first RSRP value corresponding to the first signal.

12. The first network node of claim 1, wherein the measurement information includes a standard deviation corresponding to a plurality of RSRP values, and wherein the one or more conditions include the standard deviation is greater than or less than a threshold.

13. The first network node of claim 1, wherein the measurement information or the first predicted information includes a failure probability of at least one beam of the set of beams, wherein the one or more conditions include the failure probability being greater than a threshold.

14. The first network node of claim 1, wherein the one or more conditions include a counter reaching a particular value, and wherein the at least one processor is configured to reset, increment, or decrement the counter based on at least one of the measurement information and the first predicted information.

15. The first network node of claim 1, wherein the first report includes non-predicted information, wherein the non-predicted information is associated with at least one of the measurement information or one or more signals of the set of signals.

16. The first network node of claim 1, wherein the first predicted information includes at least one predicted value, and wherein a first condition of the one or more conditions is based on at least one of at least one measured error associated with the at least one predicted value or at least one predicted error associated with the at least one predicted value.

17. The first network node of claim 16, wherein at least one of:
the at least one measured error comprises at least one difference between the at least one predicted value and at least one measured value that corresponds to a same beam as the at least one predicted value, or
the at least one predicted error comprises at least one of at least one standard deviation, at least one variance, at least one probability, or at least one likelihood.

18. The first network node of claim 16, wherein the first condition is based on a maximum measured error of the at least one measured error in comparison with a reporting threshold, and wherein the maximum measured error corresponds to a beam of the set of beams.

19. The first network node of claim 16, wherein the first condition is based on an average measured error across the at least one measured error in comparison with a reporting threshold.

20. The first network node of claim 16, wherein the first predicted information includes at least one predicted value, and wherein the first report includes at least one of:
at least one index of at least one output of a function used to determine the at least one predicted value,
at least one measured value corresponding to the at least one beam to which the at least one predicted value corresponds, or
at least one input of the function used to determine the at least one predicted value.

21. The first network node of claim 1, wherein the first predicted information includes at least one predicted value, and wherein the one or more conditions comprises at least one of:
a respective condition for each respective output port of a plurality of output ports of a function used to determine the at least one predicted value; or
a same condition for all of the plurality of output ports of the function.

22. The first network node of claim 21, wherein the at one or more conditions are based on at least one of:
at least two conditions specific to at least two of the plurality of output ports that are of a different type,
at least two thresholds specific to at least two of the plurality of output ports that are different,
a maximum predicted value of the at least one predicted value across the plurality of output ports,
a minimum predicted value of the at least one predicted value across the plurality of output ports, or
an average predicted value of the at least one predicted value across the plurality of output ports.

23. The first network node of claim 1, wherein the at least one processor is further configured to:
receive, from the second network node, information configuring communication with the second network node via one of the set of beams based on the first report; and
communicate with the second network node via the one of the set of beams.

24. A first network node for wireless communication, comprising:
a memory; and
at least one processor coupled to the memory, wherein the at least one processor is configured to:
receive, from a second network node, a first report including first predicted information corresponding to at least one first beam of a set of beams with which to communicate with the second network node, the first predicted information being based on a set of signals respectively corresponding to a subset of the set beams;
select at least one second beam of the set of beams based on the first predicted information;
transmit, to the second network node, information identifying the at least one second beam of the set of beams; and
communicate with the second network node via the at least one second beam of the set of beams.

25. The first network node of claim 24, wherein the at least one processor is further configured to transmit, to the second network node, a configuration associated with the first report, wherein at least one of the reception of the first report or the first predicted information is based on the configuration.

26. The first network node of claim 24, wherein, to receive the first report, the at least one processor is configured to:
receive uplink control information (UCI) including the first report on a periodic resource or a semi-persistent resource (SPS); or
receive a medium access control (MAC) control element (CE) (MAC-CE) including the first report.

27. The first network node of claim 26, wherein the periodic resource is on a physical uplink control channel (PUCCH) or the SPS resource is on the PUCCH or a physical uplink shared channel (PUSCH).

28. The first network node of claim 26, wherein the periodic resource or the SPS resource is shared with a second report, and the second report is one of:
multiplexed with the first report on the one of the periodic resource or the SPS resource, or
unscheduled on the one of the periodic resource or the SPS resource based a first priority associated with the first report and a second priority associated with the second report.

29. The first network node of claim 24, wherein the first report includes at least one of:
at least one identifier (ID) associated with the set of signals,
at least one transmission configuration indicator (TCI) state,
at least one index of an output of a function associated with the first predicted information,
at least one predicted reference signal received power (RSRP) value,
at least one predicted signal-to-noise ratio (SNR) value,
at least one confidence score associated with the first predicted information, or at least one predicted value and at least one of:
a probability or a likelihood that the at least one predicted value will fall below a threshold, or
at least one timestamp associated with the at least one predicted value.

30. The first network node of claim 24, wherein the first report includes non-predicted information, wherein the non-predicted information is associated with at least one of: the measurement information or one or more signals of the set of signals.

31. The first network node of claim 24, wherein the first predicted information includes at least one predicted value and at least one of:
at least one measured error associated with the at least one predicted value, or
at least one predicted error associated with the at least one predicted value.

32. The first network node of claim 31, wherein at least one of:
the at least one measured error comprises at least one difference between the at least one predicted value and at least one measured value that corresponds to a same beam as the at least one predicted value, or
the at least one predicted error comprises at least one of at least one standard deviation, at least one variance, at least one probability, or at least one likelihood.

33. The first network node of claim 31, wherein the at least one measured error comprises at least one maximum measured error that corresponds to a beam of the set of beams.

34. The first network node of claim 31, wherein the at least one measured error comprises at least one average measured error that corresponds to at least two beams of the set of beams.

35. The first network node of claim 24, wherein the first report further comprises at least one of:
at least one index of at least one output of a function that is associated with the first predicted information,
at least one measured value corresponding to the at least one beam to which the first predicted information corresponds, or
at least one input of the function that is associated with the first predicted information.

36. The first network node of claim 35, wherein the at least one processor is further configured to reconfigure a network-side function used for selection of the at least one second beam of the set of beams based on the at least one of the at least one index of the at least one output, the at least one measured value, or the at least one input.

37. The first network node of claim 24, wherein the at least one processor is further configured to schedule a set of resources on which to communicate with the second network node based on the first predicted information, wherein the communication with the second network node is further based on the schedule of the set of resources.
